(19) United States
(12) Patent Application Publication
(10) Pub. No.: US 2026/0161005 A1
(43) Pub. Date: Jun. 11, 2026

(54) Systems, Methods, And Devices For Optical Output Generation

(71) Applicant: EUV Tech, Inc., Martinez, CA (US)

(72) Inventor: Seth Cousin, Fairfield, CA (US)

(21) Appl. No.: 18/972,418

(22) Filed: Dec. 6, 2024

(51) Int. Cl. G02B 27/09; G02B 5/00; G02F 1/35; G02F 1/355; H05G 2/00

(52) U.S. Cl. CPC G02B 27/0927; G02B 5/001; G02B 27/0988; G02F 1/354; H05G 2/00; G02F 1/355

(57) ABSTRACT

Systems, methods, and devices disclosed herein generate optical outputs based on spatial profile shaping. Devices include a plurality of optical elements configured to receive a beam of a first light from a light source, the first light having a first wavelength, the plurality of optical elements being configured to change a spatial distribution of the beam of first light to an annular spatial distribution. Devices include a focusing element configured to receive a first optical output of the plurality of optical elements, and configured to focus the annular spatial distribution at a focal point, an interaction medium positioned based on the focal point and configured to undergo high-harmonic generation of a second light having a second wavelength based on the first light, and an optical aperture configured to block first light that passes through the interaction medium, and further configured to transmit the second light as a second optical output.

### FIELD OF TECHNOLOGY

This patent application relates generally to optical output generation, and more specifically to spatial profile control used in such optical output generation.

### BACKGROUND

The generation and usage of optical outputs may be applied in a variety of contexts, such as that of a semiconductor manufacturing process. For example, such optical outputs may be used for imaging, measurement, and defect detection in optical masks used for lithography and etching of materials, such as silicon wafers. However, conventional techniques for generating such optical outputs remain limited because they are not able to effectively and efficiently generate light used for such optical outputs.

### SUMMARY

In some embodiments, techniques described herein relate to a device including: a plurality of optical elements configured to receive a beam of a first light from a light source, the first light having a first wavelength, the plurality of optical elements being configured to change a spatial distribution of the beam of first light to an annular spatial distribution; a focusing element configured to receive a first optical output of the plurality of optical elements, and further configured to focus the annular spatial distribution at a focal point; an interaction medium positioned based on the focal point and configured to undergo high-harmonic generation of a second light having a second wavelength based on the first light; and an optical aperture configured to block first light that passes through the interaction medium, and further configured to transmit the second light as a second optical output.

In some embodiments, the plurality of optical elements includes a plurality of axicons. In some embodiments, the plurality of axicons includes a first axicon configured to reflect the first light and change a spatial distribution of the first light from a Gaussian spatial distribution to the annular spatial distribution; and a second axicon configured to reflect light from the first axicon and direct the annular spatial distribution towards the focusing element. In some embodiments, the focusing element includes an optical lens.

In some embodiments, the interaction medium is configured to generate extreme ultraviolet light based on high-harmonic interactions. In some embodiments, the second light is extreme ultraviolet light, and wherein the second wavelength is shorter than the first wavelength. In some embodiments, the optical aperture is configured to block off-axis light emitted from the interaction medium relative to a central axis of the received beam of first light. In some embodiments, the first light that passes through the interaction medium has an off-axis angle, and at least some of the second light generated by the interaction medium has an on-axis angle. In some embodiments, the off-axis angle is determined based, at least in part, on a focal length of the focusing element.

Also disclosed herein are systems that include a light source configured to generate a beam of a first light having a first wavelength; a plurality of optical elements configured to receive the beam of the first light, the plurality of optical elements being further configured to change a spatial distribution of the beam of first light to an annular spatial distribution; a focusing element configured to receive a first optical output of the plurality of optical elements, and further configured to focus the first optical output at a focal point; an interaction medium positioned at the focal point and configured to undergo high-harmonic generation of a second light having a second wavelength based on the first light; and an optical aperture configured to block first light that passes through the interaction medium, and further configured to transmit the second light as a second optical output.

Further disclosed herein are methods that include receiving, at a plurality of optical elements, a beam of a first light from a light source, the first light having a first wavelength, changing, using the plurality of optical elements, a spatial distribution of the beam of first light to an annular spatial distribution; focusing, using a focusing element, the beam at a focal point; generating, using an interaction medium positioned at the focal point, a second light having a second wavelength, the second light being generated via high-harmonic interactions; and blocking, using an optical aperture, first light that passes through the interaction medium and transmitting the second light as a second optical output.

These and other embodiments are described further below with reference to the figures.

### BRIEF DESCRIPTION OF THE DRAWINGS

The included drawings are for illustrative purposes and serve only to provide examples of possible structures and operations for the disclosed inventive systems, apparatus, methods, and devices for optical output generation. These drawings in no way limit any changes in form and detail that may be made by one skilled in the art without departing from the spirit and scope of the disclosed implementations.

FIG. 1 illustrates an example of a system for optical output generation, configured in accordance with some embodiments.

FIG. 2 illustrates an example of a device for optical output generation, configured in accordance with some embodiments.

FIG. 3 illustrates another example of a device for optical output generation, configured in accordance with some embodiments.

FIG. 4 illustrates an example of a method for optical output generation, performed in accordance with some embodiments.

FIG. 5 illustrates another example of a method for optical output generation, performed in accordance with some embodiments.

FIG. 6 illustrates an additional example of a method for optical output generation, performed in accordance with some embodiments.

### DETAILED DESCRIPTION

Optical outputs may be generated for a variety of applications, such as imaging, measurement, and defect detection in optical masks used for lithography and etching of materials, such as silicon wafers. In various embodiments, a process of high harmonic generation (HHG) may be used to generate such optical outputs in which laser pulses are usually focused through a medium, resulting in spatially-overlapped, colinearly propagating laser-like light that is much lower in wavelength than the generating laser initially provided to the medium. The conversion efficiency of the process may be relatively low (ranging from 10-4 to 10-8), so even at moderate laser power, the resulting output may have both a short wavelength component produced by HHG, and a long wavelength component that originated from the initial laser source and had relatively minimal and inefficient interaction with the medium for conversion. Accordingly, a generated optical output produced via HHG may include both of these short and long wavelength components.

In various embodiments, the short wavelength component may be desired for the above-identified applications, such as imaging and defect detection. Access to the short wavelength light may be provided by filtering out the spatially overlapped, co-propagating, collinear laser light. Conventional techniques for accessing the short wavelength light remain limited because they often rely on on-axis filtering that is inefficient and results in relatively low optical output brightness/amplitude.

Embodiments disclosed herein provide an optical assembly to spatially shape the intensity profile of a laser beam, without significant loss of laser power, such that short wavelength and long wavelength components of a generated optical output may be spatially separated allowing for efficient isolation of the short wavelength component and efficient filtration of the long wavelength component. More specifically, a near field (out-of-focus) part of the beam may be shaped to have an annular spatial profile, while in a far field (at focus) part of the beam has a spatial profile that is a near Gaussian distribution or near Bessel distribution, where most of the energy is in the central peak. As will be discussed in greater detail below, such shaping of the spatial profile of a received optical input may facilitate efficient and effective isolation of the short wavelength optical output generated via HHG interactions.

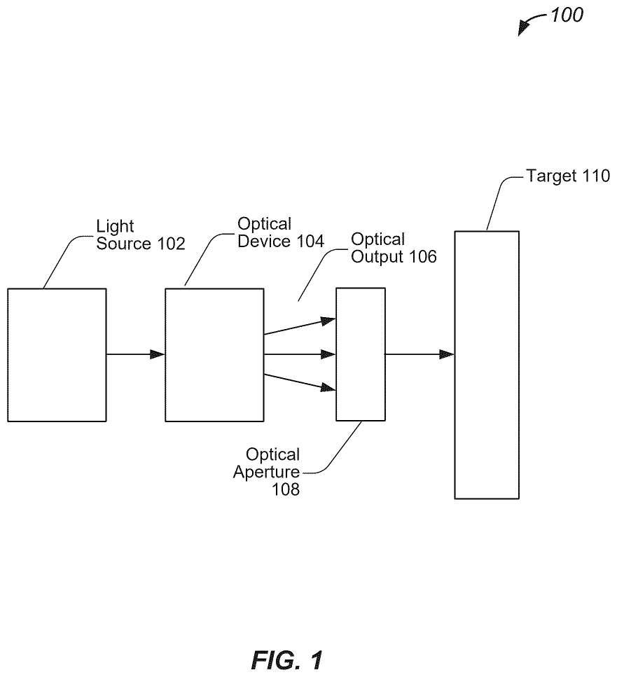

FIG. 1 illustrates an example of a system for optical output generation, configured in accordance with some embodiments. As similarly discussed above, systems, such as system 100, may be used to generate optical outputs that may be used in a variety of contexts, such as imaging and defect detection for lithography systems. As will be discussed in greater detail below, systems disclosed herein may be configured to provide spatial shaping of an optical input that enables the efficient isolation of a generated short wavelength component of an optical output, and improves an overall efficiency of optical output generation.

System 100 includes light source 102 which may be a laser light source. In various embodiments, laser light provided by light source 102 may be used as an excitation laser for high harmonic generation. Accordingly, light source 102 may be configured to generate laser light having a first wavelength which may be a longer wavelength an output ultimately provided to a target, such as target 110. It will be appreciated that light source 102 may generate laser light having any suitable parameters for HHG interactions. In one example, light source 102 may be a femtosecond-duration laser.

System 100 additionally includes optical device 104 which is configured to provide spatial shaping for the laser light received from light source 102. As will be discussed in greater detail below, optical device 104 may include various reflective devices that are configured to shape the spatial distribution of the laser light received from light source 102. The shaped spatial profile is then provided to an interaction medium that may facilitate the generation of shorter wavelength light via HHG interactions. A focusing element may be used to focus the spatial profile of the laser light towards and through the interaction medium such that optical output 106 is generated and includes the short wavelength HHG-generated light on-axis and colinear to the originally received laser light. Optical output 106 also includes the shaped spatial profile of laser light that may experience relatively minimal and inefficient HHG interactions, and may be emitted off-axis. Accordingly, as will be discussed in greater below, light provided to the focusing element may have a shaped spatial distribution in which a profile of beam intensity of the light may be focused to a Gaussian or Bessel distribution at a focal point within the interaction medium, and may revert to the shaped spatial distribution once passing beyond the focal point.

As will also be discussed in greater detail below, system 100 further includes optical aperture 108 that is configured to receive optical output 106, and is configured to filter optical output 106 to isolate the short wavelength HHG-generated light. In various embodiments, optical aperture 108 may be configured to block the transmission of light around a periphery of an aperture, and allow transmission of light at a center of the beam and on-axis. Accordingly, the shaped spatial profile that passes through the interaction medium may be blocked by optical aperture 108, and the short wavelength HHG-generated light may pass through to a target, such as target 110 which may include an object, such as a lithography mask, subject to imaging and/or defect detection operations.

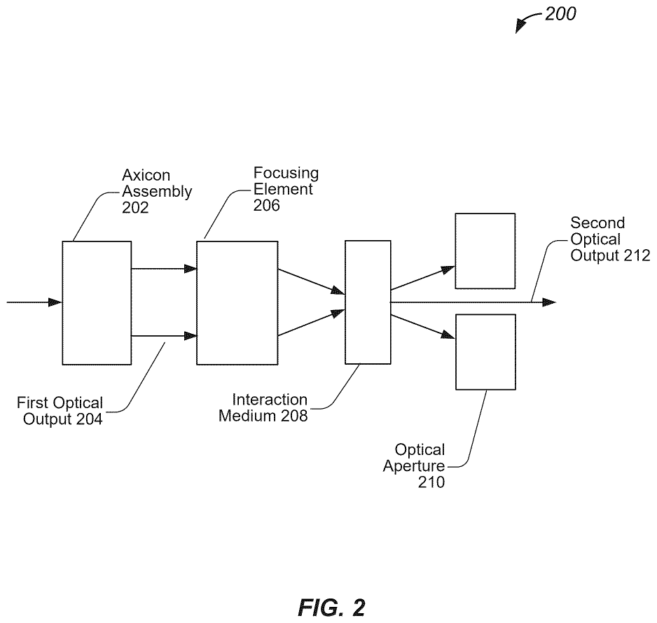

FIG. 2 illustrates an example of a device for optical output generation, configured in accordance with some embodiments. As similarly discussed above, devices, such as device 200, may be used to generate optical outputs that may be used in a variety of contexts, such as imaging and defect detection for lithography systems. As will be discussed in greater detail below, devices disclosed herein may be configured to utilize a configuration of optical components to provide spatial shaping for optical output generation.

In various embodiments, device 200 includes axicon assembly 202 that includes a plurality of axicons configured to shape a spatial distribution of light received from a light source. As similarly discussed above, the received light may be laser light that has a gaussian spatial distribution such that a center spot of the beam has a highest intensity, and the beam intensity falls off with increasing distance from the center of the beam where such fall off occurs in accordance with a gaussian distribution.

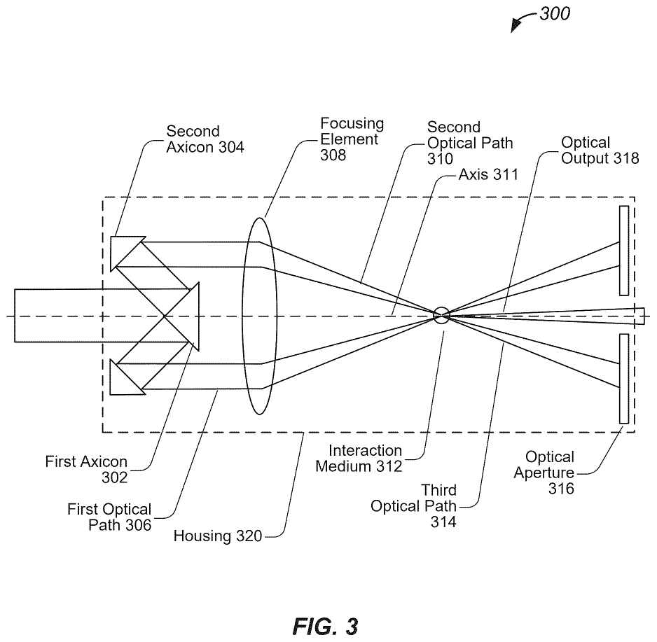

In various embodiments, axicon assembly 202 includes optical elements that are configured to shape the spatial distribution of the received light to divert the beam intensity away from the center of the beam, and to form a ring-shaped distribution, when viewed as a cross-section. Accordingly, as will be discussed in greater detail below with reference to FIG. 3, axicon assembly 202 may include reflective elements configured to reflect the received light to generate first optical output 204 that has a ring-like spatial distribution. Such optical elements may axicons, other types of lenses, or any suitable reflective or optical device. Accordingly, first optical output 204 may have a light intensity distributed in a periphery ring, and a center spot might have little to no light intensity.

Device 200 additionally includes focusing element 206 which is configured to focus first optical output 204 at a designated focal point, and thus cause first optical output 204 to converge at the designated focal point. As shown in FIG. 2, focusing element 206 may be configured to focus first optical output 204 at interaction medium 208 which is configured to facilitate HHG optical output generation. Accordingly, focusing element 206 may include one or more lenses configured to focus the spatial distribution of first optical output 204 at interaction medium 208, and the light included in first optical output 204 may interact with the material of interaction medium 208. As discussed above, such interactions may be HHG interactions that generate a high-energy output having a second wavelength associated with second optical output 212. Moreover, interaction medium 208 may include a material which may be a solid or gas selected based on optical properties of the received light, and more specifically, selected based on its physical properties that facilitate HHG interactions based on the light included in first optical output 204. It will be appreciated that any suitable material or gas may be used for interaction medium 208. It will also be appreciated that interaction medium 208 may include a housing or enclosure configured to store the material or gas used for interaction medium 208.

In various embodiments, light that has relatively minimal and inefficient interaction with interaction medium 208 may maintain its angle imparted by focusing element 206, and may thus pass through interaction medium 208 in an off-axis manner that is not parallel to a central axis of the originally received laser light. Moreover, the optical output generated via HHG interactions may generate light that has a component that is on-axis and is parallel to the central axis of the originally received laser light. Accordingly, the angle imparted by focusing element 206 may provide angular separation between light having a first wavelength associated with the originally received laser light, and light having a second wavelength associated with an HHG output generated via interaction medium 208.

As shown in FIG. 2, optical aperture 210 may be configured to block off-axis light, thus blocking the component of first optical output 204 that has relatively minimal and inefficient HHG interactions and passes through interaction medium 208. In this way, optical aperture 210 is configured to utilize the difference in angular trajectories of first optical output 204 and second optical output 212 to separate the two, and to block portions of first optical output 204 that have passed through interaction medium 208. Accordingly, an output of device 200 may be second optical output 212 that includes on-axis short wavelength HHG-generated light, and does not include long wavelength excitation laser light.

FIG. 3 illustrates another example of a device for optical output generation, configured in accordance with some embodiments. As similarly discussed above, devices, such as device 300, may be used to generate optical outputs that may be used in a variety of contexts, such as imaging and defect detection for lithography systems. As will be discussed in greater detail below, devices disclosed herein may utilize a configuration of multiple axicons to provide spatial shaping for optical output generation. Accordingly, different axicons may be used to provide stages of spatial shaping of a received optical input, and such spatial shaping may facilitate separation of such a received optical input and a generated optical output.

As similarly discussed above, FIG. 3 illustrates a cross-section of device 300 that may be configured to receive light from a light source. Such received light may be laser light that has a gaussian spatial distribution such that a center spot of the beam has a highest intensity, and the beam intensity falls off as a distance from the center of the beam increases, where such fall off occurs in accordance with a gaussian distribution.

As shown in FIG. 3, received light may first reflect off of first axicon 302, and be reflected backwards and in a radially angled manner to create a ring-like spatial distribution of light that is reflected backwards and outwards in an off-axis manner. Thus, according to various embodiments, first axicon 302 is configured to have optical properties that are configured to reflect the received on-axis light backwards in a ring-like spatial distribution. In one example, such optical properties may be implemented via an axial prism having a first axicon angle configured to generate the ring-like spatial distribution having a designated diameter, as may be determined by an entity, such as a manufacturer.

Light reflected off of first axicon 302 may then be reflected again off of second axicon 304 which may reflect the light forward and parallel to the initial axis of the received light, which may be axis 311. Accordingly, as shown in FIG. 3, second axicon 304 may generate an optical output that includes the received light now shaped in a ring-like spatial distribution and projected along first optical path 306. Accordingly, second axicon 304 may have a geometry that is complimentary to first axicon 302, and restores a forward direction and on-axis trajectory of the received light. As similarly discussed above, second axicon 304 may also include an axial prism having a second axicon angle configured based on the first axicon angle, and configured to impart a forward direction to the received light that is collinear with axis 311. As shown in FIG. 3, the spatial distribution of the intensity of the light is now distributed in a periphery ring, and not at a center of the initially received beam. In various embodiments, the optical output of second axicon 304 may be collimated light.

The optical output of second axicon 304 may be provided to focusing element 308 which is configured to focus the optical output at a designated focal point. Accordingly, focusing element 308 may include an optical lens that is configured to converge the received optical output at a focal point determined based on the focal length of the lens. In some embodiments, the combination of first axicon 302 and second axicon 304 provides beam size expansion which effectively increases a size of the received beam of light. Such beam size expansion allows greater flexibility in the determination of a focal length of focusing element 308, thus relaxing focal length design parameters.

In various embodiments, interaction medium 312 is positioned at the focal point of the lens such that the optical output of second axicon 304 that has been focused by focusing element 308 converges at interaction medium 312. As discussed above, interaction medium 312 is made of a material configured to undergo HHG processes in response to receiving the light initially provided by the light source. More specifically, interaction medium 312 is configured to be made of a material that generates extreme ultraviolet light, or any suitable shorter wavelength light such as soft X-ray, via such HHG processes, and does so in response to receiving intermittent pulses of light generated by the light source. In some embodiments, interaction medium 312 may include a gas, such as a noble gas. It will be appreciated that any suitable material may be used.

As discussed above, not all of the light provided via second optical path 310 may undergo HHG interactions. Accordingly, some light may pass through interaction medium 312 and may travel along third optical path 314. Moreover, light generated by the HHG interactions may be emitted in multiple directions including along the path shown by optical output 318. As shown in FIG. 3, light that passes through interaction medium 312 may have an off-axis angle that was imparted by focusing element 308, and light generated via HHG interactions in interaction medium 312 may have an on-axis component. In various embodiments, optical aperture 316 may be configured to block off-axis light, thus blocking the light traveling along third optical path 314. Moreover, optical aperture 316 is configured to allow on-axis light to pass through to a target, as discussed above.

As discussed above, the light initially received from the light source may be laser light received from an excitation laser. Furthermore, the received laser light may have a relatively longer wavelength that might not be useful, or might even be destructive, for the target application. The HHG light may have a shorter wavelength that may be used for the target application which, as discussed above, may be an imaging or defect detection application. Accordingly, the spatial shaping and separation of off-axis light enables device 300 to separate the longer wavelength light from the shorter wavelength light, and generate optical aperture 316 that includes only the shorter wavelength light. It will be appreciated that one or more components of device 300 may be included in a housing, such as housing 320, configured to provide structural support for such components. Accordingly, axicons, focusing element 308, and optical aperture 316 may be coupled to such a housing that may be included in an optical device, as discussed above with reference to FIG. 1. In some embodiments, optical aperture 316 may be integrated with housing 320, and may be part of housing 320.

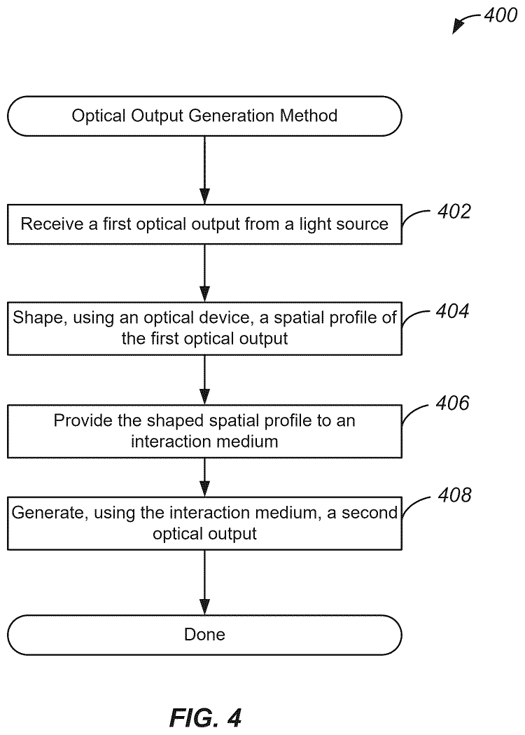

FIG. 4 illustrates an example of a method for optical output generation, performed in accordance with some embodiments. As similarly discussed above, optical outputs may be generated and may be used in a variety of contexts, such as imaging and defect detection for lithography systems. As will be discussed in greater detail below, methods disclosed herein, such as method 400, may be performed to spatially shape an optical input, and to enable the efficient isolation of a generated short wavelength component.

Method 400 may perform operation 402 during which a first optical output may be received from a light source. As discussed above, the first optical output may be laser light generated by an excitation laser. Accordingly, the laser light may be generated as a first optical output by the light source, and may be provided as an input to one or more components, such as an optical device.

Method 400 may perform operation 404 during which the optical device may be used to shape a spatial profile of the first optical output. As similarly discussed above, reflective elements of the optical device may be used to spatially shape a received laser beam into a substantially annular spatial shape. For example, the received first optical output may have a substantially Gaussian spatial distribution. The optical device may shape the Gaussian spatial distribution into an annular spatial distribution of collimated light.

Method 400 may perform operation 406 during which the shaped spatial profile may be provided to an interaction medium. As similarly discussed above, the shaped spatial profile may include an annular spatial distribution light that is collimated. As also discussed above, the collimated light may be provided to a focusing element that may focus the shaped spatial distribution at the interaction medium, thus configuring the entry and exit angles of light provided to the interaction medium, and also configuring the light received from the light source included in the first optical output to exit the interaction medium in an off-axis angle.

Method 400 may perform operation 408 during which a second optical output may be generated using the interaction medium. As also discussed above, the light included in the first optical output may interact with the interaction medium to generate an HHG-based second optical output. The second optical output may have a shorter wavelength than the first optical output, and may be the desired optical output used for a target application, such as lithography mask defect detection. Accordingly, during operation 408, the second optical output may be generated based on HHG-based interactions. Moreover, an optical aperture may be used to block off-axis light, thus isolating the short wavelength component generated via HHG interactions.

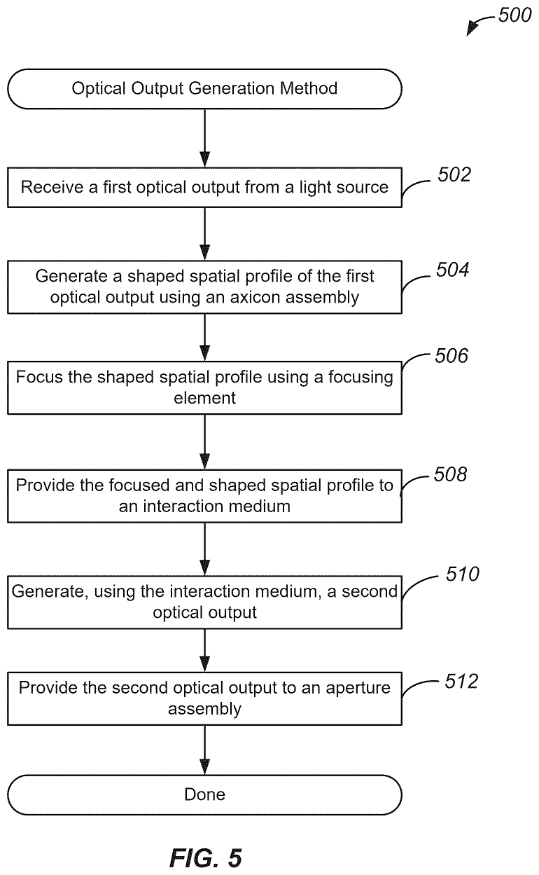

FIG. 5 illustrates another example of a method for optical output generation, performed in accordance with some embodiments. As similarly discussed above, optical outputs may be generated and may be used in a variety of contexts, such as imaging and defect detection for lithography systems. As will be discussed in greater detail below, methods disclosed herein, such as method 500, may be performed to use an axicon assembly to spatially shape an optical input, and to enable the efficient isolation of a generated short wavelength component.

Method 500 may perform operation 502 during which a first optical output may be received from a light source. As discussed above, the first optical output may be laser light generated by an excitation laser. Accordingly, the laser light may be generated as a first optical output by the light source, and may be provided as an input to one or more components, such as an axicon assembly. In one example, during operation 502, collimated laser light may be received from an excitation laser by the axicon assembly.

Method 500 may perform operation 504 during which a shaped spatial profile of the first optical output may be generated using the axicon assembly. As similarly discussed above, the axicon assembly may include multiple axicons that are configured to spatially shape the received laser light into a substantially annular spatial shape. More specifically, the received laser light may have a substantially Gaussian spatial distribution. As discussed above with reference to FIG. 3, the received laser light may be reflected off of a first axicon to provide an initial shaping of the spatial profile of the beam into an annular spatial distribution. Moreover, the light may again be reflected off of a second axicon to generate an annular spatial distribution that is now forward propagating, collimated, and parallel to the axis of the initially received laser light.

Method 500 may perform operation 506 during which the shaped spatial profile may be focused using a focusing element. As similarly discussed above, the annular spatial distribution of light may be provided to a focusing element that may focus the annular spatial distribution at an interaction medium. Accordingly, a geometry and optical properties of the focusing element may impart an angle to the annular spatial distribution of light to cause the light to converge at a focal point determined based on such optical properties. As discussed above, the focusing element may include one or more optical lenses configured to achieve such focal length.

Method 500 may perform operation 508 during which the focused and shaped spatial profile may be provided to an interaction medium. As similarly discussed above, an interaction medium may be positioned at the focal length. Accordingly, during operation 508, the shaped spatial profile may be provided to the interaction medium via the focusing element.

Method 500 may perform operation 510 during which a second optical output may be generated using the interaction medium. As similarly discussed above, the light included in the shaped spatial profile may include the first optical output from the excitation laser, and such light may interact with the interaction medium to generate an HHG-based second optical output. The second optical output may have a shorter wavelength than the first optical output, and may be the desired optical output used for a target application, such as lithography mask defect detection. Accordingly, during operation 510, HHG interactions may occur to generate the second optical output. Moreover, as also discussed above, some light included in the first optical output might not interact with the interaction medium and may pass through the interaction medium.

Method 500 may perform operation 512 during which the second optical output may be provided to an aperture assembly. Accordingly, the aperture assembly may include an optical aperture that is configured to block off-axis light. As discussed above, the longer wavelength light from the excitation laser may have an off-axis angle imparted by the focusing element, and thus be blocked by the aperture assembly. Moreover, the shorter wavelength light generated via HHG interactions may be on-axis, and may pass through the aperture assembly. In this way, efficient separation between the two wavelength components may be achieved.

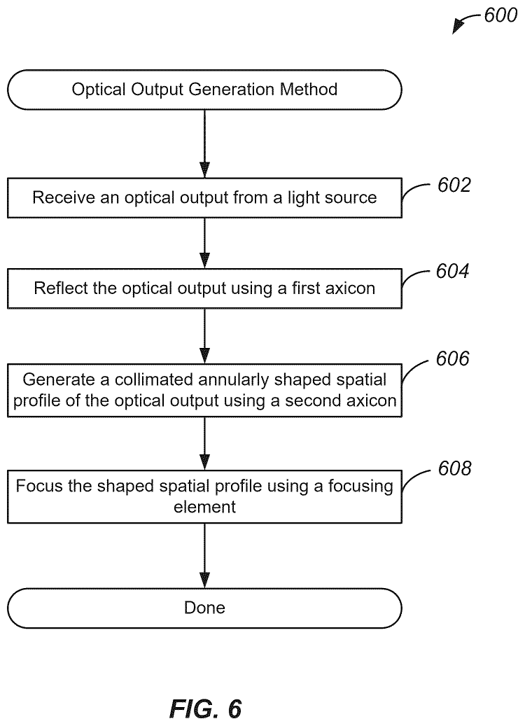

FIG. 6 illustrates an additional example of a method for optical output generation, performed in accordance with some embodiments. As similarly discussed above, optical outputs may be generated and may be used in a variety of contexts, such as imaging and defect detection for lithography systems. As will be discussed in greater detail below, methods disclosed herein, such as method 600, may be performed to use various different axicons to spatially shape an optical input, and to enable the efficient isolation of a generated short wavelength component.

Method 600 may perform operation 602 during which an optical output may be received from a light source. As discussed above, the optical output may be laser light generated by an excitation laser. Accordingly, the laser light may be generated as an optical output by the light source, and may be provided as an input to one or more components, such as an optical device.

Method 600 may perform operation 604 during which the optical output may be reflected using a first axicon. As similarly discussed above, the light received from the light source may initially have an on-axis Gaussian distribution. The optical output may be provided to the first axicon and may be reflected backwards by the first axicon in an annular ring-shaped distribution. Accordingly, the geometry of the first axicon is configured to provide such spatial shaping of the spatial distribution of the optical output when reflecting the optical output.

Method 600 may perform operation 606 during which an annularly shaped spatial profile of collimated light may be generated using a second axicon. In various embodiments, the ring-like distribution reflected by the first axicon may be provided to a second axicon that is configured to reflect the optical output forwards and in a collimated manner that is parallel to the original axis of the received optical output. In this way, an output of the second axicon is a ring-shaped distribution of light that has a diameter that is greater than the originally received beam of light that had a centrally focused Gaussian distribution.

Method 600 may perform operation 608 during which the shaped spatial profile may be shaped using a focusing element. Accordingly, the ring-shaped distribution may be provided to a focusing element which may be configured to converge the ring at a designated location. As discussed above, the designated location may be an interaction medium. Accordingly, the shaped spatial profile may be focused at the interaction medium, and any light that does not undergo HHG interactions may pass through the interaction medium at an off-axis angle imparted, at least in part, by the focusing element.

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

What is claimed is:

1. A device comprising:
a plurality of optical elements configured to receive a beam of a first light from a light source, the first light having a first wavelength, the plurality of optical elements being configured to change a spatial distribution of the beam of first light to an annular spatial distribution;
a focusing element configured to receive a first optical output of the plurality of optical elements, and further configured to focus the annular spatial distribution at a focal point;
an interaction medium positioned based on the focal point and configured to undergo high-harmonic generation of a second light having a second wavelength based on the first light; and
an optical aperture configured to block first light that passes through the interaction medium, and further configured to transmit the second light as a second optical output.

2. The device of claim 1, wherein the plurality of optical elements comprises a plurality of axicons.

3. The device of claim 2, wherein the plurality of axicons comprises:
a first axicon configured to reflect the first light and change a spatial distribution of the first light from a Gaussian spatial distribution to the annular spatial distribution; and
a second axicon configured to reflect light from the first axicon and direct the annular spatial distribution towards the focusing element.

4. The device of claim 1, wherein the focusing element comprises an optical lens.

5. The device of claim 1, wherein the interaction medium is configured to generate extreme ultraviolet light based on high-harmonic interactions.

6. The device of claim 5, wherein the second light is extreme ultraviolet light, and wherein the second wavelength is shorter than the first wavelength.

7. The device of claim 1, wherein the optical aperture is configured to block off-axis light emitted from the interaction medium relative to a central axis of the received beam of first light.

8. The device of claim 7, wherein first light that passes through the interaction medium has an off-axis angle, and wherein at least some of the second light generated by the interaction medium has an on-axis angle.

9. The device of claim 7, wherein the off-axis angle is determined based, at least in part, on a focal length of the focusing element.

10. A system comprising:
a light source configured to generate a beam of a first light having a first wavelength;
a plurality of optical elements configured to receive the beam of the first light, the plurality of optical elements being further configured to change a spatial distribution of the beam of first light to an annular spatial distribution;
a focusing element configured to receive a first optical output of the plurality of optical elements, and further configured to focus the first optical output at a focal point;
an interaction medium positioned at the focal point and configured to undergo high-harmonic generation of a second light having a second wavelength based on the first light; and
an optical aperture configured to block first light that passes through the interaction medium, and further configured to transmit the second light as a second optical output.

11. The system of claim 10, wherein the plurality of optical elements comprises:
a first axicon configured to reflect the first light and change a spatial distribution of the first light from a Gaussian spatial distribution to the annular spatial distribution; and
a second axicon configured to reflect light from the first axicon and direct the annular spatial distribution towards the focusing element.

12. The system of claim 10, wherein the focusing element comprises an optical lens, and wherein the interaction medium is configured to generate extreme ultraviolet light based on high-harmonic interactions.

13. The system of claim 12, wherein the second light is extreme ultraviolet light, and wherein the second wavelength is shorter than the first wavelength.

14. The system of claim 10, wherein the optical aperture is configured to block off-axis light emitted from the interaction medium relative to a central axis of the received beam of first light.

15. The system of claim 14, wherein first light that passes through the interaction medium has an off-axis angle, wherein at least some of the second light generated by the interaction medium has an on-axis angle, and wherein the off-axis angle is determined based, at least in part, on a focal length of the focusing element.

16. A method comprising:
receiving, at a plurality of optical elements, a beam of a first light from a light source, the first light having a first wavelength,
changing, using the plurality of optical elements, a spatial distribution of the beam of first light to an annular spatial distribution;
focusing, using a focusing element, the beam at a focal point;
generating, using an interaction medium positioned at the focal point, a second light having a second wavelength, the second light being generated via high-harmonic interactions; and
blocking, using an optical aperture, first light that passes through the interaction medium and transmitting the second light as a second optical output.

17. The method of claim 16, wherein the changing of the spatial distribution further comprises:
reflecting, using a first axicon, the first light and changing a spatial distribution of the first light from a Gaussian spatial distribution to the annular spatial distribution; and
reflecting, using a second axicon, light from the first axicon to direct the annular spatial distribution towards the focusing element.

18. The method of claim 16 further comprising:
generating extreme ultraviolet light via the high-harmonic interactions, wherein the second light is extreme ultraviolet light, and wherein the second wavelength is shorter than the first wavelength.

19. The method of claim 16, wherein the blocking of the first light comprises:
blocking, using the optical aperture, off-axis light emitted from the interaction medium relative to a central axis of the received beam of first light.

20. The method of claim 19, wherein first light that passes through the interaction medium has an off-axis angle, and wherein at least some of the second light generated by the interaction medium has an on-axis angle.
